(19) United States
(12) Patent Application Publication
(10) Pub. No.: US 2014/0218813 A1
(43) Pub. Date: Aug. 7, 2014

(54) LENS UNIT

(71) Applicant: OLYMPUS CORPORATION, Tokyo (JP)

(72) Inventors: Hiroyuki Araki, Tokyo (JP); Toshiya Sodeyama, Tokyo (JP); Hideaki Ichikawa, Tokyo (JP)

(73) Assignee: OLYMPUS CORPORATION, Tokyo (JP)

(21) Appl. No.: 14/250,910

(22) Filed: Apr. 11, 2014

Related U.S. Application Data
(63) Continuation of application No. PCT/JP2013/001034, filed on Feb. 22, 2013.

(30) Foreign Application Priority Data
Feb. 23, 2012 (JP) 2012-038008

(51) Int. Cl. G02B 7/02

(52) U.S. Cl. CPC G02B 7/021
USPC 359/819

(57) ABSTRACT

A lens unit (LU) holding at least two lenses (4, 5) in a lens frame (1) adjacently in the optical axis direction and provided with positioning protrusions (2c, 2d) formed in correspondence with each of the two lenses (4, 5) in at least three separate locations in the peripheral direction of the lens frame (1), protruding from the inner surface of the lens frame (1) and contacting a peripheral surface of a corresponding lens to position the corresponding lens relative to the lens frame (1), an adhesive filling space (GSP1) formed between the peripheral surface of each of the two lenses (4, 5) and the inner surface of the lens frame (1) in overlap with the two lenses (4, 5), and an adhesive injection hole (1c) formed in the lens frame (1) in communication with the adhesive filling space (GSP1).

### CROSS-REFERENCE TO RELATED APPLICATION

The present application is a Continuing Application based on International Application PCT/JP2013/001034 filed on Feb. 22,2013, which, in turn, claims priority to and the benefit of Japanese Patent Application No. 2012-038008 filed on Feb. 23, 2012, the entire contents of which are incorporated herein by reference.

### TECHNICAL FIELD

The present invention relates to a lens unit provided with a plurality of lenses and a lens frame holding the lenses.

### BACKGROUND ART

A compact lens unit that holds a plurality of lenses forming an optical imaging system is used as a camera component in, for example, a vehicle-mounted camera for viewing behind or to the sides of the vehicle, a surveillance camera, a digital camera, a camera cell phone, or the like.

Examples of known lens units include a lens unit in which a plurality of lenses are inserted in the lens frame by being stacked, along with necessary spacers, in order from the lens with the smallest outside diameter to the lens with the largest outside diameter. After positioning each lens within the lens frame, adhesive is injected from a plurality of through-holes formed on the peripheral surface of the lens frame, and each lens is adhesively secured to the lens frame at a plurality of locations along the peripheral surface of the lens (for example, see JP2009-244393A (PTL 1) and JP2010-134379A (PTL 2)).

### CITATION LIST

### Patent Literature

PTL 1: JP2009-244393A

PTL 2: JP2010-134379A

### SUMMARY OF INVENTION

A lens unit according to the present invention is a lens unit holding at least two lenses in a lens frame adjacently in an optical axis direction, comprising: positioning protrusions formed in correspondence with each of the two lenses in at least three separate locations in a peripheral direction of the lens frame, protruding from an inner surface of the lens frame and contacting a peripheral surface of a corresponding lens to position the corresponding lens relative to the lens frame; at least one adhesive filling space formed between the peripheral surface of each of the two lenses and the inner surface of the lens frame, in overlap with the two lenses; and at least one adhesive injection hole formed in the lens frame in communication with the adhesive filling space.

The lens frame may hold at least three lenses adjacently in the optical axis direction, the positioning protrusions may be formed in correspondence with each of the three lenses, the at least one adhesive filling space may comprise a plurality of adhesive filling spaces formed in correspondence respectively with a first pair of adjacent lenses, among the three lenses, that includes a lens positioned at one side in the optical axis direction and a second pair of adjacent lenses that includes a lens positioned at the other side in the optical axis direction, and the at least one adhesive injection hole may comprise a plurality of adhesive injection holes aligned along the optical axis direction in correspondence respectively with the first pair of adjacent lenses and the second pair of adjacent lenses.

The positioning protrusions may be formed at six locations in correspondence with each of the lenses, and the at least one adhesive filling space and the at least one adhesive injection hole may comprise a plurality of adhesive filling spaces and a plurality of adhesive injection holes formed at three separate locations in the peripheral direction.

The positioning protrusions may have an arc-shape in a cross-section orthogonal to the optical axis and may be in line contact with the peripheral surface of the corresponding lens.

### BRIEF DESCRIPTION OF DRAWINGS

The present invention will be further described below with reference to the accompanying drawings, wherein:

FIG. 1 is a cross-sectional diagram schematically illustrating the configuration of a lens unit according to an embodiment of the present invention;

FIG. 2 is an exploded perspective view of the lens unit in FIG. 1;

FIG. 3 illustrates a front view and a side view of the elastic member in FIG. 1;

FIG. 4 is a perspective view of the inner portion of the lens frame in FIG. 1 from the object side aperture;

FIG. 5 is a cross-sectional diagram of the lens frame in FIG. 1; and

FIG. 6 illustrates external views of the lens unit in FIG. 1 viewed from directions differing by 180°.

### DESCRIPTION OF EMBODIMENTS

The following describes an embodiment of the present invention with reference to the drawings.

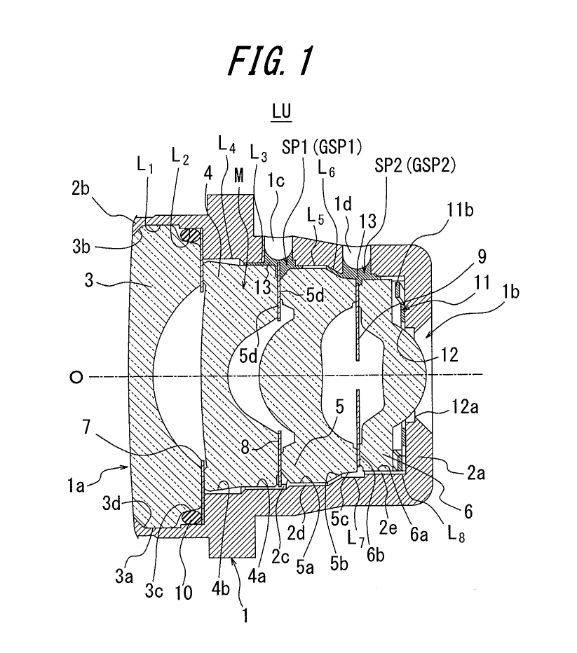

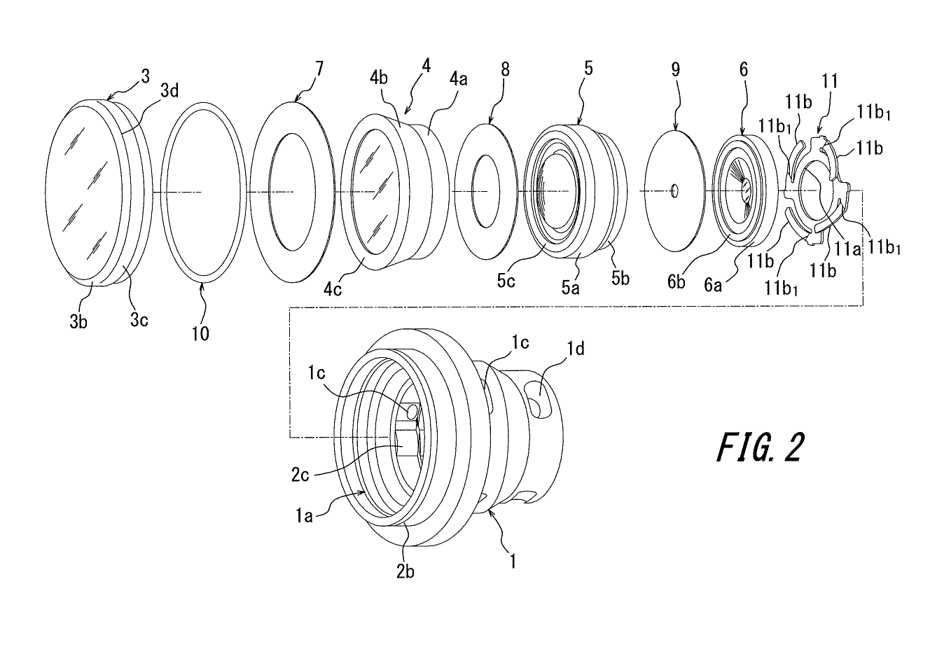

FIG. 1 is a cross-sectional diagram schematically illustrating the configuration of a lens unit according to an embodiment of the present invention. FIG. 2 is an exploded perspective view of the lens unit in FIG. 1.

As illustrated in FIGS. 1 and 2, a lens unit LU of the present embodiment forms an optical imaging system, for example, and includes a lens frame 1 that holds a lens group M formed by four lenses: a fourth lens 3, a third lens 4, a second lens 5, and a first lens 6 in this order along an optical axis O. The maximum outside diameter of each lens decreases in the order of the fourth lens 3, third lens 4, second lens 5, and first lens 6. In the present disclosure, for the sake of convenience, the fourth lens 3 side is referred to as the object side (the left side in the figures), and the first lens 6 side as the image side (the right side in the figures). For each lens, the face at the object side is also referred to as the front face, and the face at the image side as the back face.

The lens frame 1 is formed by an annular peripheral wall made of plastic or metal material and includes an object side aperture 1a and an image side aperture 1b that respectively open to the object side and the image side. Light from the object enters into the lens frame 1 from the object side aperture 1a, passes through the lens group M, and exits from the image side aperture 1b.

A diaphragm wall 2a that both constitutes a lens end face supporting member for the lens group M and forms the image side aperture 1b is provided at the image side end of the lens frame 1. The image side aperture 1b is formed in the diaphragm wall 2a so as to expose a central portion that includes the optical axis of the first lens 6 positioned at the image side.

The fourth lens 3 is formed by a glass concave meniscus lens, with the convex face at the object side, and is supported by the lens frame 1 by a lens edge entire periphery supporting member 2b formed by swaging the object side end of the lens frame 1. The fourth lens 3 is arranged so that an equal-diameter outer peripheral surface 3a thereof is fit on an equal-diameter inner peripheral surface L1 formed on the lens frame 1, and so that the optical axis of the fourth lens 3 is positioned along the optical axis O. A chamfered portion 3b is formed along the entire peripheral edge of the convex face. By swaging, the entire periphery of the chamfered portion 3b is supported by the lens edge entire periphery supporting member 2b. The object side aperture 1a is formed by the lens edge entire periphery supporting member 2b. The lens edge entire periphery supporting member 2b supports the chamfered portion 3b of the fourth lens 3 so that the object side surface of the lens edge entire periphery supporting member 2b continues at nearly the same curvature as the convex face. An outer peripheral side corner 3d of the chamfered portion 3b is corner rounded.

A concavity 3c is formed along the entire periphery of the back face edge of the fourth lens 3. A seal member 10, formed for example from an O ring, is sandwiched between this concavity 3c and an equal-diameter inner peripheral surface L2 formed on the lens frame 1. Note that the diameter of the equal-diameter inner peripheral surface L2 is smaller than the diameter of the equal-diameter inner peripheral surface L1.

The third lens 4 is formed by a plastic concave meniscus lens. On the outer peripheral surface thereof, an equal-diameter outer peripheral surface 4a is formed at the end by the concave face side, and a slanted outer peripheral surface 4b is formed so that the outside diameter increases continuously from the equal-diameter outer peripheral surface 4a to the convex face side. With the convex face at the object side, the third lens 4 is arranged so that the equal-diameter outer peripheral surface 4a is fit to be in contact with positioning protrusions 2c formed to protrude from an equal-diameter inner peripheral surface L3 of the lens frame 1, and so that the optical axis of the third lens 4 is positioned along the optical axis O. In this state, the slanted outer peripheral surface 4b is positioned by an equal-diameter inner peripheral surface L4 formed on the lens frame 1.

The positioning protrusions 2c are formed at six locations separated by equal intervals in the peripheral direction of the equal-diameter inner peripheral surface L3. Details on the positioning protrusions 2c are provided below. Note that the diameter of the equal-diameter inner peripheral surface L3 is smaller than the diameter of the equal-diameter inner peripheral surface L4. Furthermore, on the front face of the third lens 4, a chamfered abutment 4c is formed to be in surface contact with the back face of the fourth lens 3 with a flare diaphragm 7 therebetween.

The second lens 5 is formed from a plastic convex lens and includes a flange. On an outer peripheral surface of the flange, an equal-diameter outer peripheral surface 5a is formed at the end of the convex face side having the larger curvature, a slanted outer peripheral surface 5b is formed so that the outside diameter decreases continuously from the equal-diameter outer peripheral surface 5a to the convex face side having the smaller curvature, and an equal-diameter outer peripheral surface 5c is formed continuously from the slanted outer peripheral surface 5b. With the convex face having the larger curvature at the object side, the second lens 5 is arranged so that the equal-diameter outer peripheral surface 5a is fit to be in contact with positioning protrusions 2d formed to protrude from an equal-diameter inner peripheral surface L5 of the lens frame 1, and so that the optical axis of the second lens 5 is positioned along the optical axis O. In this state, the slanted outer peripheral surface 5b faces a slanted inner peripheral surface L6 formed on the lens frame 1 with a gap therebetween, and the equal-diameter outer peripheral surface 5c faces an equal-diameter inner peripheral surface L7 formed on the lens frame 1 with a gap therebetween.

The positioning protrusions 2d are formed at six locations separated by equal intervals in the peripheral direction of the equal-diameter inner peripheral surface L5. Details on the positioning protrusions 2d are provided below. Note that the slanted inner peripheral surface L6 is formed so that the diameter decreases from the equal-diameter inner peripheral surface L5 towards the equal-diameter inner peripheral surface L7. Furthermore, on the front face of the flange of the second lens 5, a chamfered abutment 5d is formed to be in surface contact with the back face of the third lens 4 with a flare diaphragm 8 therebetween. In the lens frame 1, within a region that avoids the positioning protrusions 2c of the third lens 4 and the positioning protrusions 2d of the second lens 5, a space SP1 is formed between the peripheral surfaces of the lenses and the inner peripheral surface of the lens frame 1, in overlap with the third lens 4 and the second lens 5.

The first lens 6 is formed from a plastic convex lens and includes a flange. With the convex face side having the larger curvature at the image side, the first lens 6 is arranged so that an equal-diameter outer peripheral surface 6a of the flange is fit to be in contact with positioning protrusions 2e formed to protrude from an equal-diameter inner peripheral surface L8 of the lens frame 1, and so that the optical axis of the first lens 6 is positioned along the optical axis O. The positioning protrusions 2e are formed at six locations separated by equal intervals in the peripheral direction of the equal-diameter inner peripheral surface L8. Details on the positioning protrusions 2e are provided below.

On the front face of the flange of the first lens 6, a chamfered abutment 6b is formed to be in surface contact with the back face of the second lens 5 with an aperture diaphragm 9 therebetween. The first lens 6 is arranged so that a convex surface central portion at the image side protrudes from the image side aperture 1b formed by the diaphragm wall 2. The outer peripheral surface edges of the third lens 4, the second lens 5, and the first lens 6 are chamfered as necessary. In the lens frame 1, within a region that avoids the positioning protrusions 2d of the second lens 5 and the positioning protrusions 2e of the first lens 6, a space SP2 is formed between the peripheral surfaces of the lenses and the inner peripheral surface of the lens frame 1, in overlap with the second lens 5 and the first lens 6.

The flare diaphragm 7 is arranged to fit on the equal-diameter inner peripheral surface L2 between the fourth lens 3 and the third lens 4, so that the center (optical axis) of the flare diaphragm 7 is positioned along the optical axis O. The flare diaphragm 8 is arranged to fit on the positioning protrusions 2d between the third lens 4 and the second lens 5, so that the center (optical axis) of the flare diaphragm 8 is positioned along the optical axis O. The aperture diaphragm 9 is arranged to fit on the equal-diameter inner peripheral surface L7 between the second lens 5 and the first lens 6, so that the center (optical axis) of the aperture diaphragm 9 is positioned along the optical axis O.

The flare diaphragms 7 and 8 prevent the passage of harmful light, which does not contribute to imaging or the like, and are formed by a sheet-shaped member such as a polyester sheet or the like. Delustering treatment is applied to the surface, for example by application of black paint, in order to prevent reflection. The aperture diaphragm 9 controls brightness by limiting the diameter of the axial pencil of rays passing through the lens group M. Like the flare diaphragms 7 and 8, the aperture diaphragm 9 is formed by a sheet-shaped member such as a polyester sheet or the like, and delustering treatment is applied to the surface, for example by application of black paint, in order to prevent reflection. Note that the flare diaphragms 7 and 8 and the aperture diaphragm 9 can also be formed by application of black paint directly on the edge face of the lens or by applying delustering treatment.

An elastic member 11 formed from a blade spring is arranged between the first lens 6 and the diaphragm wall 2. With a repulsive force produced by pressure when the fourth lens 3 is disposed on the equal-diameter inner peripheral surface L1, the elastic member 11 causes the edge surfaces of the lenses 3, 4, 5, and 6 to be in contact elastically with each other (elastic support) via the diaphragms 7, 8, and 9 and positions the lenses 3, 4, 5, and 6 in the optical axis direction within the lens frame 1.

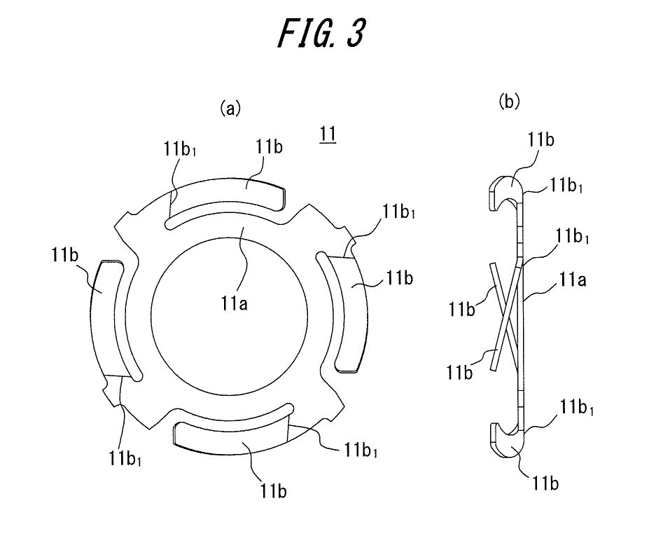

FIGS. 3(a) and (b) are a front view and a side view of the elastic member 11. The elastic member 11 is larger than the image side aperture 1b formed in the diaphragm wall 2 and is formed by a thin annular base 11a, which is provided with an aperture through which the central portion of the first lens 6 can pass, and by a plurality of blade-shaped arms 11b that are integrally connected to the outer edge of the annular base 11a so as to be supported at one side. At the base of each of the arms 11b, a bent portion 11b₁ is formed to act as an elastic piece that causes the arm 11b to bend in the direction of thickness and that suppresses the tip from spreading outwards in the radial direction when a repulsive force is produced in the arm 11b.

In FIGS. 1 and 2, on the inner surface of the diaphragm wall 2a, a stopper 12 is provided near the image side aperture 1b. Upon application of external stress, such as a shock or the like to the lens unit LU, before the stopper 12 abuts an aperture edge 12a defining the image side aperture 1b, the stopper 12 abuts a region further outwards in the radial direction than an effective region corresponding to the image side aperture 1b of the first lens 6. Damage to the effective region of the first lens 6 is thus prevented. Note that the stopper 12 may be formed by an annular convexity or by a plurality of protrusions arranged at intervals.

Adhesive injection holes 1c that penetrate from the outer surface to the inner surface of the lens frame 1, so as to communicate with the space SP1 that is formed in a region overlapping the third lens 4 and the second lens 5, are formed in the lens frame 1 at three locations separated by equal intervals in the peripheral direction. Similarly, adhesive injection holes 1d that penetrate from the outer surface to the inner surface of the lens frame 1, so as to communicate with the space SP2 that is formed in a region overlapping the second lens 5 and the first lens 6, are formed in the lens frame 1 at three locations separated by equal intervals in the peripheral direction. Details on the adhesive injection holes 1c and 1d are provided below. The spaces SP1 and SP2 communicating with the adhesive injection holes 1c and 1d are respectively referred to as adhesive filling spaces GSP1 and GSP2, and these adhesive filling spaces GSP1 and GSP2 are filled with adhesive 13 from the adhesive injection holes 1c and 1d. In this way, the third lens 4, second lens 5, and first lens 6 are adhesively fixed to the lens frame 1 along with the flare diaphragm 8 and the aperture diaphragm 9.

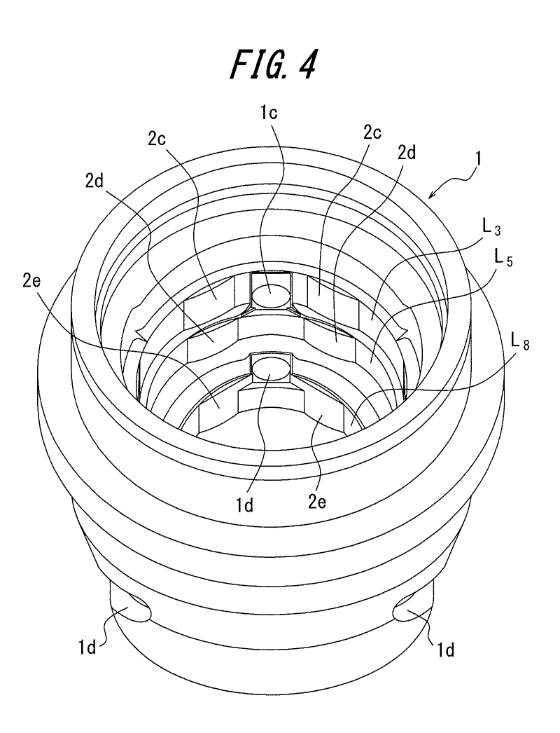

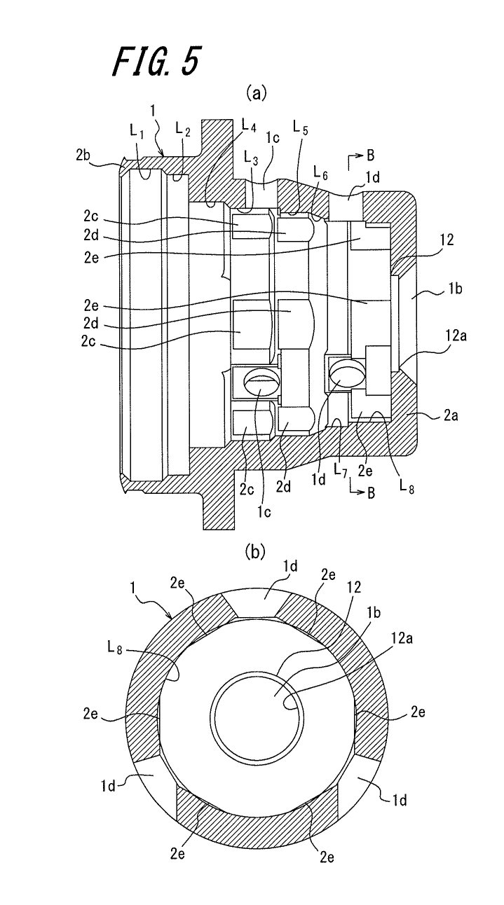

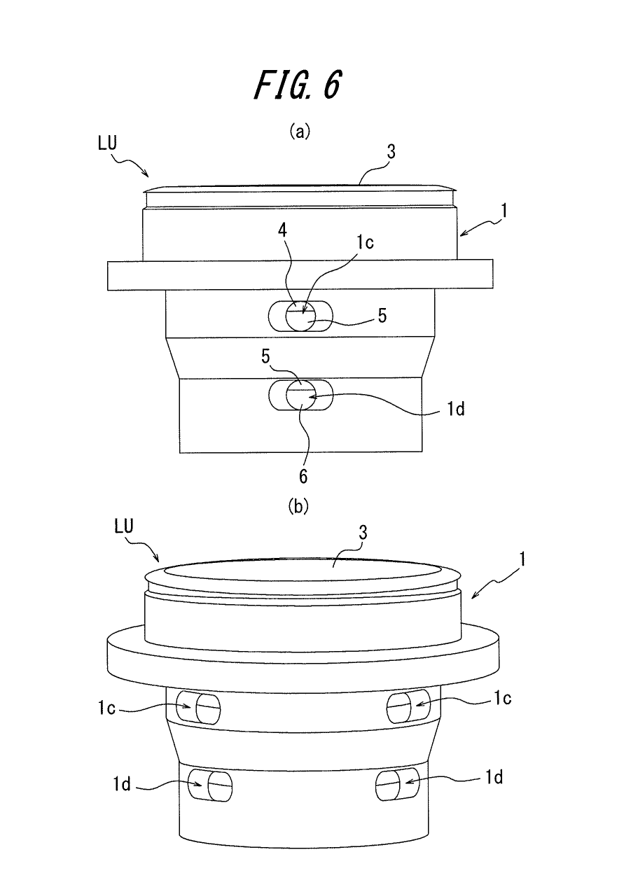

Next, the positioning protrusions 2c of the third lens 4, the positioning protrusions 2d of the second lens 5, the positioning protrusions 2e of the first lens 6, and the adhesive injection holes 1c and 1d are described with reference to FIGS. 4 through 6. FIG. 4 is a perspective view of the inner portion of the lens frame 1 from the object side aperture 1a. FIGS. 5(a) and (b) are cross-sectional diagrams of the lens frame 1. FIG. 5(a) is a cross-sectional diagram along the optical axis, and FIG. 5(b) is a cross-sectional diagram along the line B-B in FIG. 5(a). FIGS. 6(a) and (b) are external views of the lens unit LU viewed from directions differing by 180°.

The positioning protrusions 2c, 2d, and 2e extend in the optical axis direction, and a cross-section that is orthogonal to the optical axis is arc-shaped. In other words, the shape is that of a cylinder cut in the axial direction. These positioning protrusions 2c, 2d, and 2e are each formed at six locations separated by equal intervals in the peripheral direction and are aligned in the optical axis direction. Accordingly, the first lens 6 is arranged so that the equal-diameter outer peripheral surface 6a thereof fits in line contact with the six positioning protrusions 2e, thereby positioning the optical axis. Similarly, the second lens 5 is arranged so that the equal-diameter outer peripheral surface 5a thereof fits in line contact with the six positioning protrusions 2d, thereby positioning the optical axis. The third lens 4 is arranged so that the equal-diameter outer peripheral surface 4a thereof fits in line contact with the six positioning protrusions 2c, thereby positioning the optical axis.

Three of the adhesive injection holes 1c are formed at equal intervals in the peripheral direction between adjacent positioning protrusions 2c and adjacent positioning protrusions 2d when viewing from the optical axis direction, and so as to overlap the third lens 4 and the second lens 5 when viewing from a direction orthogonal to the optical axis. Similarly, three of the adhesive injection holes 1d are formed at equal intervals in the peripheral direction between adjacent positioning protrusions 2d and adjacent positioning protrusions 2e when viewing from the optical axis direction, and so as to overlap the second lens 5 and the first lens 6 when viewing from a direction orthogonal to the optical axis. In other words, when viewing from the optical axis direction, the adhesive injection holes 1c are formed at positions corresponding to regions for every other one of the six positioning protrusions 2c and 2d, and the adhesive injection holes 1d are formed at positions corresponding to regions for every other one of the six positioning protrusions 2d and 2e.

As illustrated in FIG. 1, the adhesive 13 injected from each of the adhesive injection holes 1c fills the adhesive filling space GSP1 for the portion where the adhesive injection hole 1c is located. Similarly, the adhesive 13 injected from each of the adhesive injection holes 1d fills the adhesive filling space GSP2 for the portion where the adhesive injection hole 1d is located.

Next, an example of the assembly procedure for the lens unit LU of the present embodiment is described.

First, the image side aperture 1b and the stopper 12 are formed in the diaphragm wall 2 in the lens frame 1, and with the lens frame 1 positioned with the object side aperture facing upwards, the elastic member 11, first lens 6, aperture diaphragm 9, second lens 5, flare diaphragm 8, third lens 4, and flare diaphragm 7 are inserted (dropped) through the object side aperture into predetermined positions so as to be stacked in this order. In this way, the optical axis of each optical component can be positioned along the optical axis O within the lens frame 1.

Next, the fourth lens 3 is inserted along with the seal member 10 within the lens frame 1, against the elastic force of the elastic member 11, so as to be stacked above the flare diaphragm 7. In this way, the optical axis of the fourth lens 3 can be positioned along the optical axis O of the other optical components within the lens frame 1. In this state, the object side end of the lens frame 1 is thermally or mechanically deformed by swaging, the lens edge entire periphery supporting member 2b supports the chamfered portion 3b formed at the front face of the fourth lens 3 over the entire periphery and continues at nearly the same curvature as the convex front face, and the object side aperture 1a is formed by the lens edge entire periphery supporting member 2b.

As a result, the edge surfaces of the lenses 3, 4, 5, and 6 push against each other elastically via the diaphragms 7, 8, and 9 due to the elastic force of the elastic member 11, so that the lenses 3, 4, 5, and 6 and the diaphragms 7, 8, and 9 can be positioned in the optical axis direction and held between the lens edge entire periphery supporting member 2b of the lens frame 1 and the diaphragm wall 2, i.e. between the object side aperture 1a and the image side aperture 1b.

Subsequently, from the adhesive injection holes 1c and 1d, adhesive 13 is injected via a nozzle or the like, and the adhesive filling spaces GSP1 and GSP2 are filled with the adhesive 13. In this way, the first lens 6, second lens 5, and third lens 4 can be adhesively fixed to the lens frame 1 along with the aperture diaphragm 9 and the flare diaphragm 8.

As described above, in the lens unit LU of the present embodiment, after the first lens 6, second lens 5, and third lens 4 are inserted into the lens frame 1, the lens peripheral surfaces are abutted against the six positioning protrusions 2e, 2d, and 2c formed separately in the peripheral direction and protruding from the inner surface of the lens frame 1, thereby positioning the optical axis of each lens. Accordingly, when injecting adhesive 13 from the adhesive injection holes 1c and 1d, or during hardening of the injected adhesive 13, radial displacement of the first lens 6, second lens 5, and third lens 4 is restricted, so that the lenses can be adhesively secured to the lens frame 1 reliably without the occurrence of misalignment, eccentricity, or the like. As a result, a naturally hardening adhesive or the like may be used as the adhesive 13, thus increasing the degree of freedom for the adhesive that can be used. Furthermore, as compared to when the optical axes are positioned by fitting the entire peripheral surface of each of the first lens 6, second lens 5, and third lens 4 into the lens frame, the lens frame 1 can be produced easily, and the surface accuracy of the lens peripheral surface can be reduced, thereby reducing overall costs.

The adhesive filling spaces GSP1 and GSP2 are each formed in overlap with two adjacent lenses. Accordingly, as compared to when an adhesive injection hole is formed in correspondence with each lens, the number of the adhesive injection holes 1c and 1d communicating with the adhesive filling spaces GSP1 and GSP2 can be reduced. Moreover, since the adhesive injection holes 1c and 1d are aligned along the optical axis direction, it is easier to inject the adhesive 13 with an automatic machine or the like. The ease of assembly of the lens unit LU can thus be improved.

Furthermore, the slanted outer peripheral surface 5b is formed on the second lens 5, and the slanted outer peripheral surface 4b is formed on the third lens 4. Accordingly, while guaranteeing the thickness of the lens frame 1, the portion at which the outside diameter of the lens frame 1 is large can be reduced as compared to when these slanted outer peripheral surfaces are not formed, the entire outer peripheral surface of the second lens 5 is an equal-diameter outer peripheral surface with the same outside diameter as the equal-diameter outer peripheral surface 5a, and the entire outer peripheral surface of the third lens 4 is an equal-diameter outer peripheral surface with the same outside diameter as the largest outside diameter of the slanted outer peripheral surface 4b. The entire lens unit LU can thus be made more compact.

The seal member 10 is sandwiched between the concavity 3c of the fourth lens 3 and the equal-diameter inner peripheral surface L2 of the lens frame 1, thereby effectively preventing dust from entering into the lens frame 1 from the object side and also achieving a waterproofing effect. Accordingly, when the lens unit LU is mounted, for example, as an optical imaging system in a surveillance camera or the like, the lens unit LU can be used stably for an extended period of time. Furthermore, the elastic member 11 that pushes the first lens 6 elastically towards the fourth lens 3 is disposed between the first lens 6 and the diaphragm wall 2 that forms the lens end face supporting member. As a result, the edge surfaces of the lenses 3, 4, 5, and 6 push against each other elastically via the diaphragms 7, 8, and 9 due to the elastic force of the elastic member 11, so that the lenses can be positioned in the optical axis direction and held. The flare diaphragms 7 and 8 are also disposed respectively between the fourth lens 3 and the third lens 4 and between the third lens 4 and the second lens 5. Therefore, the occurrence of a flare can be reliably prevented.

The fourth lens 3 that faces the object side is a glass lens, whereas the other lenses 4, 5, and 6 are plastic lenses, and the first lens 6 that faces the image side is supported by the inner face of the diaphragm wall 2a that forms the lens end face supporting member. Accordingly, damage to the lenses held in the lens unit LU is effectively prevented while lowering the weight of the lens unit LU and further reducing the occurrence of strain in the fourth lens 3, thus more effectively preventing a reduction in optical performance. Moreover, since the aperture diaphragm 9 is disposed between the second lens 5 and the first lens 6, the diameter of each lens can be reduced, and the diameters can be made smaller successively from the fourth lens 3 to the first lens 6. As a result, the inner shape of the lens frame 1 can easily be made such that the lenses can be dropped in the order of the first lens 6, second lens 5, third lens 4, and fourth lens 3, thereby both improving the ease of assembly and making the lens unit LU more compact and lightweight.

The present invention is not limited only to the above embodiment, and a variety of modifications and changes are possible. For example, the lens group M that is held in the lens unit LU is not limited to being four lenses. Rather, the present invention may be effectively applied when at least two or more lenses are held adjacently. The shape of the positioning protrusions formed in the lens frame 1 in correspondence with each lens is not limited so that a cross-section orthogonal to the optical axis is arc-shaped. Rather, any shape in line contact with the corresponding lens may be adopted, such as a triangular shape, rectangular shape, or other shape. Furthermore, the positioning protrusions are not limited to being formed at six locations in the peripheral direction and need only be formed in at least three locations. Similarly, the adhesive filling spaces each corresponding to two adjacent lenses are not limited to being formed at three locations in the peripheral direction and may be formed at any number of locations equal to or less than the number of locations of the positioning protrusions. Accordingly, in the case of the above embodiment, the number of adhesive filling spaces may also be 1, 2, 4, 5, or 6. Furthermore, the elastic member 11 may be any shape. A rubber member may be used instead of a blade spring, or the elastic member 11 may be omitted.

25

### REFERENCE SIGNS LIST

1: Lens frame

1a: Object side aperture

1b: Image side aperture

1c, 1d: Adhesive injection hole

2a: Diaphragm wall

2b: Lens edge entire periphery supporting member

2c, 2d, 2e: Positioning protrusion

3: Fourth lens

3a: Equal-diameter outer peripheral surface

3b: Chamfered portion

3c: Concavity

3d: Outer peripheral side corner

4: Third lens

4a: Equal-diameter outer peripheral surface

4b: Slanted outer peripheral surface

4c: Abutment

5: Second lens

5a, 5c: Equal-diameter outer peripheral surface

5b: Slanted outer peripheral surface

5d: Abutment

6: First lens

6a: Equal-diameter outer peripheral surface

6b: Abutment

7, 8: Flare diaphragm

9: Aperture diaphragm

10: Seal member

11: Elastic member

11a: Annular base

11b: Arm

12: Stopper

12a: Aperture edge

13: Adhesive

LU: Lens unit

M: Lens group

L1-L5, L7, L8: Equal-diameter inner peripheral surface

L6: Slanted inner peripheral surface

GSP1, GSP2: Adhesive filling space

1. A lens unit holding at least two lenses in a lens frame adjacently in an optical axis direction, comprising:
positioning protrusions formed in correspondence with each of the two lenses in at least three separate locations in a peripheral direction of the lens frame, protruding from an inner surface of the lens frame and contacting a peripheral surface of a corresponding lens to position the corresponding lens relative to the lens frame;
at least one adhesive filling space formed between the peripheral surface of each of the two lenses and the inner surface of the lens frame, in overlap with the two lenses; and
at least one adhesive injection hole formed in the lens frame in communication with the adhesive filling space.

2. The lens unit according to claim 1, wherein
the lens frame holds at least three lenses adjacently in the optical axis direction,
the positioning protrusions are formed in correspondence with each of the three lenses,
the at least one adhesive filling space comprises a plurality of adhesive filling spaces formed in correspondence respectively with a first pair of adjacent lenses, among the three lenses, that includes a lens positioned at one side in the optical axis direction and a second pair of adjacent lenses that includes a lens positioned at the other side in the optical axis direction, and
the at least one adhesive injection hole comprises a plurality of adhesive injection holes aligned along the optical axis direction in correspondence respectively with the first pair of adjacent lenses and the second pair of adjacent lenses.

3. The lens unit according to claim 1, wherein
the positioning protrusions are formed at six locations in correspondence with each of the lenses, and
the at least one adhesive filling space and the at least one adhesive injection hole comprise a plurality of adhesive filling spaces and a plurality of adhesive injection holes formed at three separate locations in the peripheral direction.

4. The lens unit according to claim 1, wherein
the positioning protrusions have an arc-shape in a cross-section orthogonal to the optical axis and are in line contact with the peripheral surface of the corresponding lens.
